(19) United States
(12) Patent Application Publication
(10) Pub. No.: US 2012/0045180 A1
(43) Pub. Date: Feb. 23, 2012

(54) CONNECTOR ASSEMBLY WITH FLOATABLE OPTICAL TERMINATION

(75) Inventors: HSIEN-CHU LIN, New Taipei (TW); CHI-NAN LIAO, New Taipei (TW)

(73) Assignee: HON HAI PRECISION INDUSTRY CO., LTD., New Taipei (TW)

(21) Appl. No.: 13/213,097

(22) Filed: Aug. 19, 2011

(30) Foreign Application Priority Data
Aug. 20, 2010 (TW) 99216023

(51) Int. Cl. G02B 6/36

(52) U.S. Cl. 385/89; 385/88

(57) ABSTRACT

An connector assembly (100) includes an insulative housing (1) having a main portion and a tongue portion extending forwardly from the main portion, a cavity (121) defined in the tongue portion; an optical module (3) floatable inside the cavity; and a metallic shell (7) having a frame enclosing the tongue portion to form a shrunk front port located in front of the optical module.

### FIELD OF THE INVENTION

The present invention generally relates to a connector assembly, and more particularly to a connector assembly adapted for optical and electrical transmitting.

### DESCRIPTION OF PRIOR ART

In many of today's processing systems, such as personal computer (PC) systems, there exist universal serial bus (USB) ports for connecting various USB devices. Different standards of USB technology for different bandwidths have been launched by USB-IF supported by some of world largest IT companies. For instance, Universal Serial Bus Specification, revision 1.1 devices are capable of operating at 12 Mbits/second(Mbps). Universal Serial Bus Specification, revision 2.0 devices are capable of operating at 480 Mbps. Universal Serial Bus Specification, revision 3.0 devices are capable of operating at higher speed also accepted by market, gradually. However, as technology progresses engineers are constantly striving to increase operating speeds.

For example, CN Pub. Pat. No. 101345358 published on Jan. 14, 2009 discloses an optical USB connector assembly which has a fiber device added to a USB connector assembly. The fiber device has a number of fibers connected with lenses embedded in the USB connector. Thus, optical signal transmits along a first fiber and is expanded/magnified by a first lens terminated to the first fiber, and then shrunk by a second lens and runs through second fiber of a complementary connector. However, as the lenses are positioned in the insulative housing, and the lenses may not align with their counterparts of a complementary connector, if there is a relative big error in manufacturing proceeding. In other hand, a connector assemble with floatable lenses may overcome this problem. However, dust may enter interior of the connector assembly and fill in gap between the lenses and the insulative housing, which also influences usage of the connector assembly.

Hence, an improved connector assembly is highly desired to overcome the aforementioned problems.

### SUMMARY OF THE INVENTION

Accordingly, an object of the present invention is to provide a connector assembly with floatable optical termination.

In order to achieve the object set forth, a connector assembly in accordance with the present invention comprises an insulative housing having a main portion and a tongue portion extending forwardly from the main portion, a cavity defined in the tongue portion; an optical module floatable inside the cavity; and a metallic shell having a frame enclosing the tongue portion to form a shrunk front port located in front of the optical module.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of the connector assembly;

FIG. 2 is an exploded, perspective view of FIG. 2;

FIG. 3 is similar to FIG. 2, but viewed from another aspect;

FIG. 4 is a partially assembled view of the connector assembly; and

FIG. 5 is a cross-section view of the connector assembly taken along line 5-5.

### DETAILED DESCRIPTION OF PREFERRED EMBODIMENTS

Reference will now be made in detail to the preferred embodiment of the present invention.

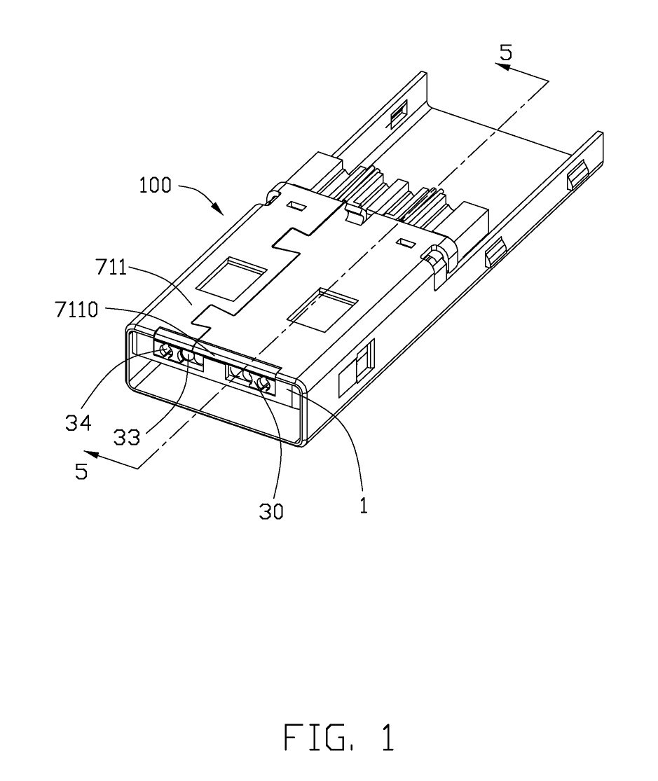

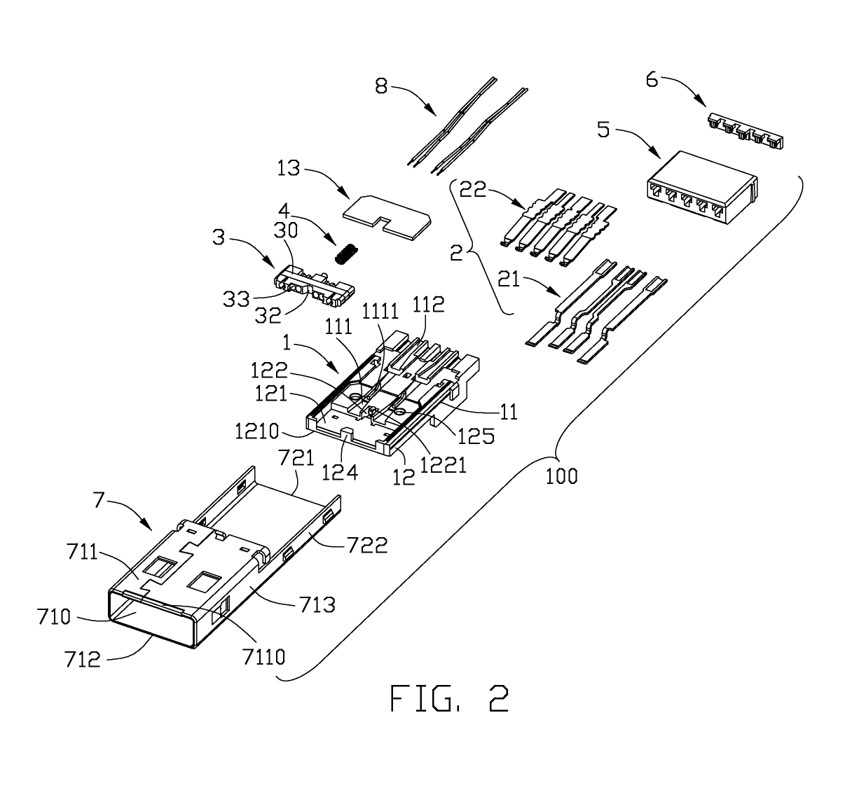

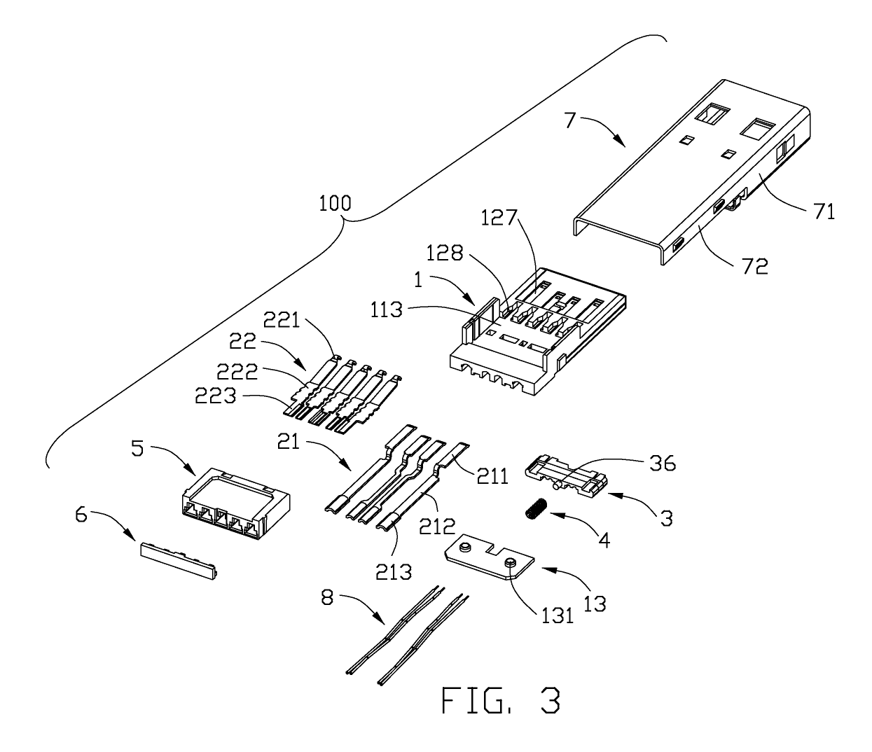

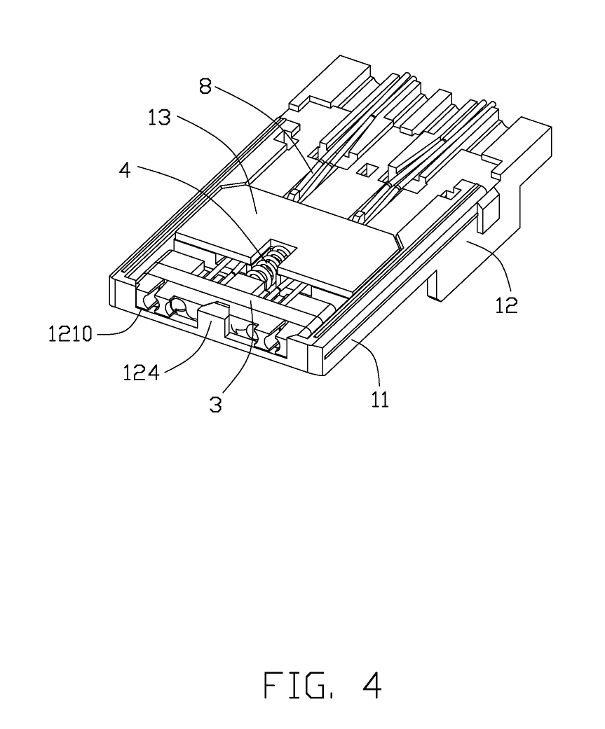

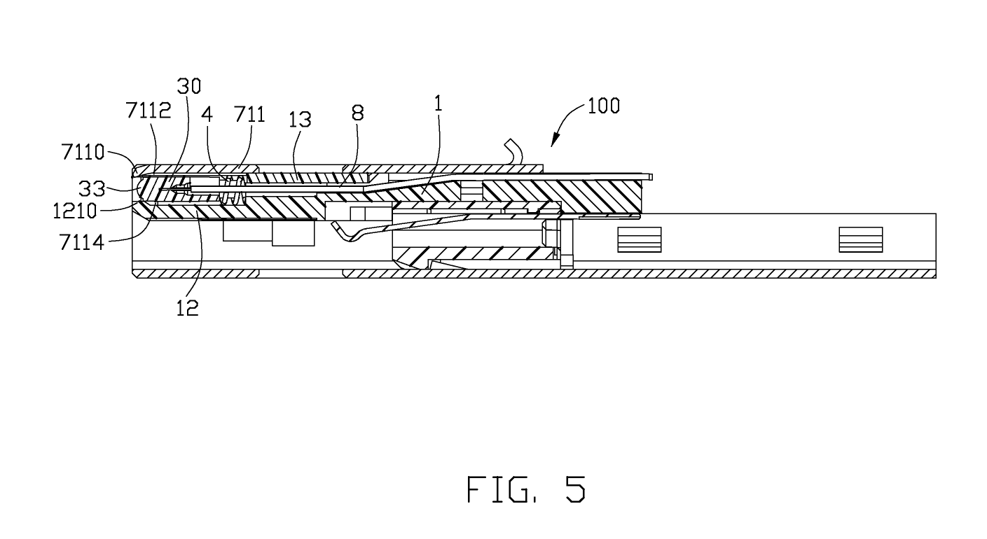

Referring to FIGS. 1-5, a connector assembly 100 in accordance with the present invention comprises an insulative housing 1, a plurality of terminals 2 retained in or supported by the insulative housing 1, an optical module 3 mounted to the insulative housing 1, an elastic member 4 sandwiched between the insulative housing 1 and the optical module 3 so as to forwardly bias the optical module 3, a terminal seat 5, a spacer 6, a metallic shell 7 shrouding the insulative housing 1, a number of fibers 8 connecting with the optical module 3.

The insulative housing 1 includes a main portion 11 and a tongue portion 12 extending forwardly from the main portion 11.

There are two fiber passages 111 located in a top side of a back segment of the tongue portion 12 and a front segment of the main portion 11. Each fiber passage 111 is tapered shape along front-to-back direction. A front part is wider than a back part of the fiber passage 111. There is a longitudinal rib 1111 formed in a middle part of the fiber passage 111 and the rib 1111 also extends along the front-to-back direction. There are two retaining slots 112 located in a back segment of the main portion 11. The retaining slot 112 is also configured to be tapered shape along the front-to-back segment. Furthermore, the retaining slot 112 communicates with the fiber passage 111. The fiber passage 111 is deeper than the retaining slot 112. There is a recess 113 located in a bottom side of the main portion 11. The terminal seat 5 is accommodated in the recess 113. There is a cavity 121 defined in a top side of a front segment of the tongue portion 12. The cavity 121 has a front opening facing forwardly and a window facing upwardly. The cavity 121 is deeper than the fiber passage 111. Also, there is a groove 122 defined in the tongue portion 12 and disposed behind the cavity 121. The groove 122 communicates with the cavity 121 too. A positioning member 1221 is located in the groove 122 and projects forwardly. The positioning member 1221 may be a post or a protrusion.

The elastic member 4 may be a coil spring. A rear segment of the elastic member 4 is accommodated in the groove 122, with the positioning member 1221 inserted therein. There is a V-shaped stopper 124 located in middle segment of a front end of the tongue portion 12. A set of first terminal grooves 127 and a set of second terminal grooves 128 defined in a bottom side of the tongue portion 12. The first terminal grooves 127 are disposed in front of the second terminal grooves 128.

An arrangement of the terminals 2 is in accordance with USB 3.0 standard. The terminals 2 are divided into a set of first terminals 21 and a set of second terminals 22. The first terminals 21 and the second terminals 22 are separated into two distinct rows along the front-to-back direction.

The set of first terminals 21 have four contact members arranged in a row along the transversal direction. Each first terminal 21 substantially includes a planar retention portion 212 supported by a bottom surface of the recess 113, a mating portion 211 raised upwardly and extending forwardly from the retention portion 212 and received in the corresponding first terminal groove 127, and a tail portion 213 extending rearward from the retention portion 212. Furthermore, the mating portion 211 and the tail portion 213 are disposed at opposite sides (bottom side and top side) of the insulative housing 1.

The set of second terminals 22 have five contact members arranged in a row along the transversal direction and combined with the terminal seat 5. The set of second terminals 22 are separated into two pairs of signal terminal for transmitting differential signals and a grounding terminals disposed between the two pair of signal terminals. Each second terminal 22 includes a planar retention portion 222 received in the terminals seat 5, a curved mating portion 221 extending forward from the retention portion 222 and disposed beyond a front surface of the terminal seat 5, and a tail portion 223 extending rearward from the retention portion 222 and disposed behind a back surface of the terminal seat 5. The spacer 6 is assembled to the terminal seat 5, with a number of ribs (not numbered) thereof inserted into the grooves (not numbered) of the terminal seat 5 to position the second terminals 22. The mating portion 221 is deformable along a upper-to-down direction and can enter the corresponding second terminal groove 128 while pressed by its counterpart of a complementary connector.

The optical module 3 includes four lens members 33 arranged in juxtaposed manner and combined with a base portion 30. The base portion 30 further defines a cutout 32 in middle segment of a front side thereof A mounting post 36 protrudes backwardly from a middle of a back side of the base portion 30.

The optical module 3 is accommodated in the cavity 121 from the window. The mounting post 36 is inserted into a front segment of the elastic member 4, and the optical module 3 is pushed forwardly and floatable within the cavity 121. The stopper 124 is accommodated in the cutout 32 to prevent the optical module 3 escaping from the insulative housing 1.

The fibers 8 extend into fiber passages 111 via the retaining slots 112 and are respectively coupled to the lenses 33 of the optical module 3. As the fiber passages 111 are configured to be tapered shape, thus there is enough space for the fibers 8 to move therein. In addition, the fibers 8 are properly inhibited within the fiber passages 111. There are two fibers 8 received in one of the fiber passages 111, and the two fibers 8 are spaced apart from each other by the rib 1111, therefore, they do not twist together. There is also a cap 13 mounted to the insulative housing 1 to shield the fiber passages 111 and the fibers 8 are positioned in the fiber passages 111. The cap 13 has two positioning members 131 formed at a bottom surface thereof and inserted into and engaged with positioning holes 125 defined in the insulative housing 1. As the optical module 3 and the terminals 2 are arranged at opposite sides of the insulative housing 1, hence it facilitates manufacturing proceed.

The metallic shell 7 includes a frame 71 and a U-shaped portion 72 connected to the frame 71. The frame 71 has a top wall 711, a bottom wall 712 and two side walls 713 connected with the top wall 711 and the bottom wall 712 to together form a rectangular shaped hollow 710. The U-shaped portion 72 has a bottom side 721 and two lateral sides 722 projecting upwardly from lateral edges of the bottom side 721. In addition, partial of front edge of the top wall 711 is bent downwardly to form an inclined protrusion 7110.

The insulative housing 1 is assembled to the metallic shell 7, with the tongue portion 12 received in the hollow 710 of the frame 71, the main portion 11 extending into the U-shaped portion 72. The optical module 3 is enclosed by the frame 71 and the tongue portion 12. There is a first gap 7112 formed between a top side of the base portion 30 and the top wall 711. The inclined protrusion 7110 is located in front of the first gap 7112. In addition, there is a second gap 7114 formed between a bottom side of the base portion 30 and a bottom surface of the cavity 121. There is a flange 1210 located in the front opening of the cavity 121 and located in front of the second gap 7114. The inclined protrusion 7110 extends downward towards the front opening of the cavity 121 and faces to the flange 1210 along an up-to-down direction. In addition, the inclined protrusion 7110 and the front opening of the cavity 121 has same dimension along a transversal direction. The base portion 30 of the optical module 3 is broader than the front opening. Thus, the optical module 3 is freely moveable/floatable inside the cavity 121. In other hand, dust is mostly prevented from entering the first gap 7112 and the second gap 7114 by the flange 1210 and the inclined protrusion 7110. That is to say, the frame 71 and the tongue portion 12 together form a shrunk or narrowed front port matching with the optical module 3 so as to decrease seam between the optical module and shrunk port. The shrunk or narrowed front port is formed by the protrusion 7110 and the flange 1210 extending into a front opening defined by the tongue portion 12 and the frame 71.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A connector assembly, comprising:
an insulative housing having a main portion and a tongue portion extending forwardly from the main portion, a cavity defined in the tongue portion;
an optical module floatable inside the cavity; and
a metallic shell having a frame enclosing the tongue portion to form a shrunk front port located in front of the optical module.

2. The connector assembly as recited in claim 1, wherein the frame has a top wall, a bottom wall and two side walls connected with each other to form the frame.

3. The connector assembly as recited in claim 2, wherein there is an inclined protrusion bent downwardly from a front edge of the top wall.

4. The connector assembly as recited in claim 3, wherein there is a first gap formed between a top side of the optical module and the top wall, and the inclined protrusion is located in front of the first gap.

5. The connector assembly as recited in claim 3, wherein there is a flange formed in the front of the cavity, and the shrunk front port is formed between the flange and the inclined protrusion.

6. The connector assembly as recited in claim 5, wherein there is a second gap formed between a bottom side of the optical module and a bottom surface of the cavity.

7. The connector assembly as recited in claim 5, wherein the flange faces to the inclined protrusion along an up-to-down direction.

8. The connector assembly as recited in claim 1, wherein there are a plurality of terminals retained in the insulative housing.

9. The connector assembly as recited in claim 1, wherein there is a spring sandwiched between the optical module and the insulative housing.

10. A connector assembly, comprising:
an insulative housing having a main portion and a tongue portion extending forwardly from the main portion, the tongue portion defining a cavity with a front opening;
an optical module moveably accommodated in the cavity; and
a metallic shell having a top wall with an inclined protrusion formed at a front edge thereof and extending downward toward the front opening.

11. The connector assembly as recited in claim 10, wherein there is a flange located in the front opening and facing to the inclined protrusion along an up-to-down direction.

12. The connector assembly as recited in claim 10, wherein the inclined protrusion and the front opening have same dimension along a transversal direction.

13. The connector assembly as recited in claim 10, wherein said optical module having a base portion and a plurality of lenses combined with the base portion.

14. The connector assembly as recited in claim 13, wherein the base portion is broader than the front opening

15. The connector assembly as recited in claim 13, there are plurality of fibers respectively coupled to the lenses of the optical module.

16. The connector assembly as recited in claim 10, wherein there is an elastic member biasing the optical module forwardly.

17. The connector assembly as recited in claim 10, wherein there are a plurality of terminals retained in the insulative housing, and the terminals are separated into two sets.

18. A connector comprising:
an insulative housing including a mating plate with opposite first and second faces in a vertical direction;
a plurality of electrical contacts disposed in the housing with contacting sections exposed upon the first face;
a cavity formed in the mating plate and recessed inward from the second face;
an optical module accommodated in the cavity and back and forth moveable along a front-to-back direction perpendicular to said vertical direction; and
a cover assembled to the housing to shield the second face; wherein the cavity defines a front opening in communication with an exterior forwardly under condition that said opening is dimensioned smaller than an average dimension of a cross-section of the cavity behind the front opening for anti-dust entry from the exterior into the cavity.

19. The connector as claimed in claim 18, wherein the front opening is formed by both the cover and the housing.

20. The connector as claimed in claim 18, wherein said cover is a metallic shell which defines a mating port on the first face for receiving a mating tongue of a complementary connector.
